(19) United States
(12) Patent Application Publication
(10) Pub. No.: US 2003/0039344 A1
(43) Pub. Date: Feb. 27, 2003

(54) Selective caller identification method and apparatus

(76) Inventor: Michael Mercer, Durham, NC (US)

Correspondence Address: James Y. Sze, Pilsbury Winthrop LLP, Intellectual Property Group, 11682 El Camino Real, Suite 200, San Diego, CA, 93102, US

(21) Appl. No.: 09/934,387

(22) Filed: Aug. 21, 2001

(51) Int. Cl. H04M 11/00; H04M 1/56

(52) U.S. Cl. 379/142.01; 379/93.23

(57) ABSTRACT

A method, apparatus, user-interface and system to support selective caller identification, the automatic transmission of a caller's identification information to a selective group of call recipients, conducted over a network, using a communications device. When selective caller identification is activated, and a caller initiates a communications session with a particular call recipient, caller's communications device determines whether that particular call recipient identifier is stored within the caller's selective caller identification database. If recipient's data is stored within the caller's selective caller identification database, then depending upon the database entry, selective caller identification will enable or disable the transmission of caller's identification information. If recipient's data is not stored within caller's selective identification database, then selective caller identification will enable or disable the transmission of caller's identification information depending upon a DEFAULT parameter.

### BACKGROUND

1. Field of the Invention

Aspects of the present invention relate in general to packet-based telephony, and a method, apparatus, user-interface, and system to allow a caller to selectively transmit the caller's identification information to call recipients.

2. Description of the Related Art

In a conventional audio telephone call, parties are remotely connected via a telephone network. For example, a caller located in California may use the telephone to communicate with a recipient, located in New York. Present technology allows the caller to manually configure his telephone equipment to transmit the caller's identification information, such as caller's name and telephone number, to all either all or no recipients. In addition, the recipient may configure his telephone to either accept or reject telephone calls initiated by the caller when the caller's identification information has not been transmitted.

If the recipient configures his telephone equipment to reject calls when the caller's identification information has not been transmitted, the recipient's telephone will not ring, and the caller will be prohibited from communicating with the recipient. In such case, if the caller wishes to complete a telephone call to the recipient, the caller must first, manually reconfigure his telephone equipment such that his identification information will be transmitted to recipient, and second, the caller must then manually redial the recipient. To reconfigure telephone equipment and redial takes additional time and is bothersome to the callers, particularly when the caller wishes to send identification information to certain recipients, but not to others.

### BRIEF DESCRIPTION OF THE DRAWINGS

FIG. 1 illustrates a communications system that facilitates communications between multiple parties and devices.

FIG. 2 depicts an apparatus embodiment that facilitates selective caller identification (SCID).

FIG. 3 is an act diagram of an apparatus embodiment that facilitates SCID.

FIG. 4 is an illustration of a user interface embodiment that facilitates SCID.

FIG. 5 is a flowchart of a method that facilitates SCID.

FIGS. 6A-B are flowcharts of a method that facilitates SCID.

FIGS. 7A-B are flowcharts of a method that facilitates SCID.

### DETAILED DESCRIPTION

An apparatus and method capable of automatically transmitting a caller's identification information to only certain call recipients is needed.

Aspects of the present invention include method, apparatus, user-interface, and system for facilitating selective caller identification (SCID). As described below, SCID may be performed over any communications network 140 as is known in the art. In some embodiments, SCID may be performed on an Internet Access Device (IAD) in conjunction with a communications network 140, such as, but not limited to, an Intelligent Network or Next Generation Network. In other embodiments, SCID may be performed through the selective transmission of caller identification information on a packet switched network.

The term “SCID,” as used herein, may refer to automatically transmitting caller identification information to a selective group of recipients upon the initiation of a communications session by a caller to a recipient.

When SCID is activated, and a caller attempts to establish a communications session with a recipient over a communications network 140, the caller's communications device 110A automatically determines whether caller's identification information should be transmitted to recipient's communications device 110B. SCID may determine whether a recipient identifier is defined within a communications database, and if not, either enable or disable the transmission of the identification information based upon the configuration of a DEFAULT parameter. The recipient identifier may comprise a telephone number, e-mail address, Internet Protocol (IP) address, name, or other piece of information that identifies a particular recipient. Caller may configure the DEFAULT parameter to either enable or disable transmission of the identification information when a recipient identifier is not defined within the communications database. If a recipient identifier is defined within the communications database, SCID will search a SEND ID field within communications database that corresponds to the recipient identifier to determine whether to enable or disable transmission of the identification information when attempting to communicate with the recipient.

SCID may be facilitated through a number of differing embodiments that selectively enable or disable the transmission of the identification information to a recipient. In one embodiment, SCID may be performed when a communications device 110, such as a telephone, acts to determine whether or not to enable or disable the transmission of caller's identification information. In other embodiments, the communications device 110 may be an Internet Access Device or telephone incorporating or coupled to an Internet Access Device.

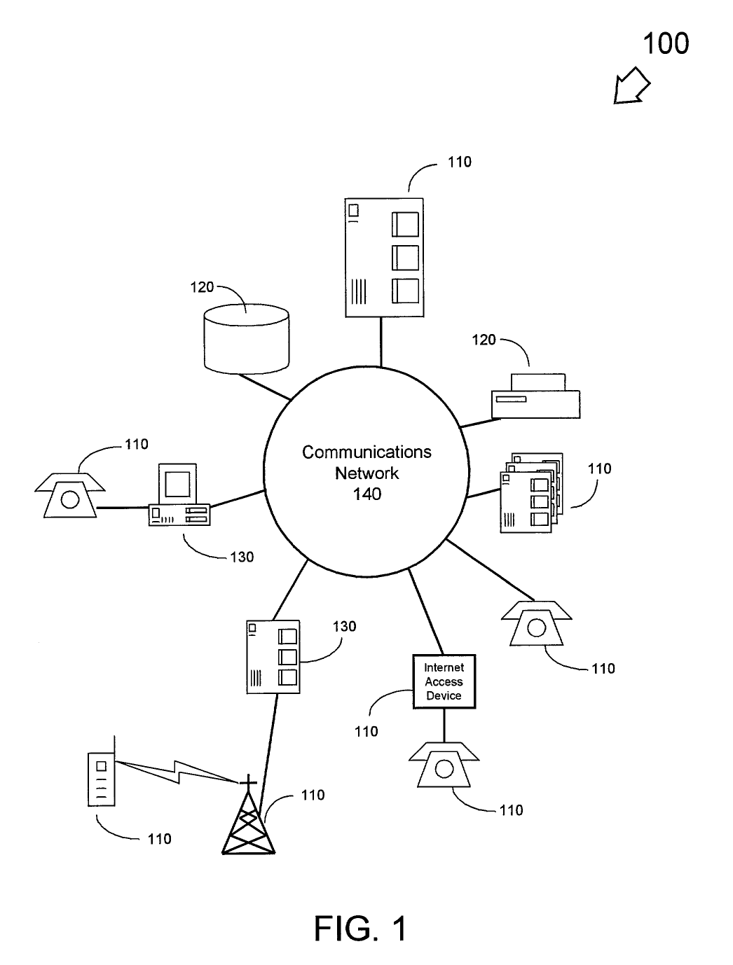

FIG. 1 is a simplified functional act diagram depicting system 100, constructed and operative in accordance with an embodiment of the present invention. System 100 is configured to facilitate the performance of SCID by a caller who attempts to conduct a communications session with a recipient over a communications network 140. In system 100, communications devices 110 are coupled to a communications network 140 either directly, through any number of additional communications devices 100, or through any number network interfaces 130. It is known in the art that communications devices 110 may be coupled via a single or multiple number of communications networks 140.

In some embodiments, communications device 110 may be an internet access device, such as a personal computer (PC), personal digital assistant (PDA), wireless telephone, or any apparatus known in the art that either is able to communicate on the communications network 140. Alternatively, the communications device 110 may be any apparatus known in the art that may be coupled to any number of additional communications devices 110 or network interfaces 130. Network interface 130 is any device that couples a communications device 110 or a communications network 140 to a communications network 140. For example a network interface 130 may be a modem, router, bridge, or hub. In addition, communications device 110 may be a conventional telephone or a wireless telephone, such as a cordless telephone, cellular telephone, or satellite telephone. In other embodiments, communications device 110 may be a server, such as a conference call server, telephone server, electronic mail server or video mail server, a wireless telephone base station, workstation, terminal, FAX machine, beeper or pager.

Communications network 140 may be any communications network known in the art, including a conventional telephone network, the Internet, a local-area-network (LAN), a wide-area-network (WAN), any system that couples a conference call server to at least one telephone, a Bluetooth network, a radio-frequency network, an Intelligent Network (IN), a Next Generation Network (NGN), or a packet switched network. In addition, the communications network 140 may be configured in accordance with any topology known in the art, including but not limited to star, ring, bus, or any combination thereof.

Communications devices 110 may be coupled to a communications network 140 that supports the receipt and transmission of digital packets. Communications devices 110 and network interfaces 130 may be configured to allow different networks to communicate with one another, as well as with a packet switch telephone network (PSTN), a plain ordinary telephone service (POTS), an Integrated Services Digital Network (ISDN), or any other communications network.

The communications network 140 may couple communications devices 110 to any number of various peripheral devices 120 as well, such as storage media and printers. Examples of other peripheral devices 120 include, but are not limited to, input devices, output devices, plotters, cameras, scanners, and modems. It is well understood in the art, that any number or variety of computer networkable devices or components may be coupled to the communications network 140 without inventive faculty, such as, but not limited to, a printer.

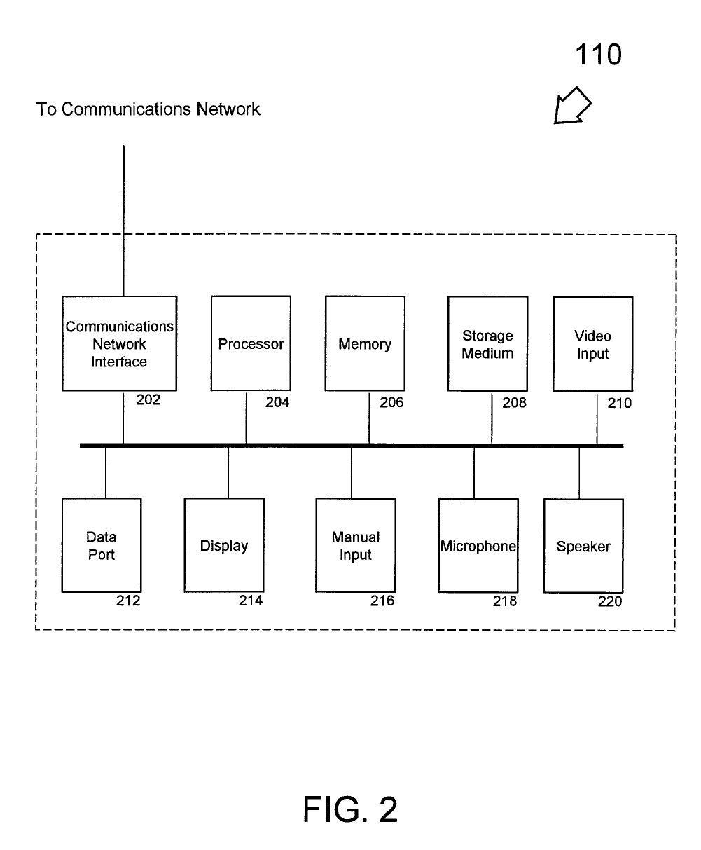

Embodiments will now be disclosed with reference to a functional act diagram of an exemplary telephone server communications device 110 of FIG. 2, constructed and operative in accordance with an embodiment of the present invention. Telephone server communications device 110 runs a multi-tasking operating system and includes at least one processor 204. Processor 204 may be any microprocessor or micro-controller as is known in the art.

The software for programming the processor 204 may be found at a computer-readable storage medium 208, or alternatively, from another location across communications network 140. Processor 204 is coupled to memory 206, and telephone server communications device 110 may be controlled by an operating system that is executed within memory 206.

Processor 204 communicates with a plurality of peripheral equipment including communications network interface 202. Additional peripheral equipment may include display 214, manual input device 216, storage medium 208, microphone 218, and data port 212.

Display 214 may be a visual display such as a cathode ray tube (CRT) monitor, a liquid crystal display (LCD) screen, touch-sensitive screen, or other monitors as are known in the art for visually displaying images and text to a user.

Manual input device 216 may be a conventional keyboard, keypad, mouse, trackball, or other input devices as are known in the art for the manual input of data.

Storage medium 208 may be a conventional read/write memory, such as a magnetic disk drive, floppy disk drive, compact-disk read-only-memory (CD-ROM) drive, transistor-based memory, or other computer-readable memory device as is known in the art for storing and retrieving data. Significantly, storage medium 208 may be remotely located from processor 204, and may be coupled to processor 204 via a communications network 140 such as, but not limited to, a local area network (LAN), wide area network (WAN), or the Internet.

Microphone 218 may be any suitable microphone as is known in the art for providing audio signals to processor 204. In addition, speaker 220 may be coupled to communications device 110 for reproducing audio signals from processor 204. Video input 210 may be a digital or analog video camera device to record still or moving images. In some embodiments, video input 210 may be a scanner device. It is understood that microphone 218, speaker 220, and video input 210 may include digital-to-analog and analog-to-digital conversion circuitry as appropriate.

Data port 212 may be any data port as is known in the art for interfacing with an external accessory using a data protocol such as, but not limited to, RS-232, Universal Serial Bus (USB), or Institute of Electrical and Electronics Engineers (IEEE) Standard No. 1394 (“Firewire”). In some embodiments, data port 212 may be any interface as known in the art for communicating or transferring files across a computer network. Examples of such network include Transmission Control Protocol/Internet Protocol (TCP/IP), Ethernet, Fiber Distributed Data Interface (FDDI), Bluetooth, token bus, or token ring networks. In addition, on some systems, data port 212 may consist of a modem connected to a communications network interface 202, thereby allowing the telephone server communications device 110 to communicate and process input and output from a telephone line.

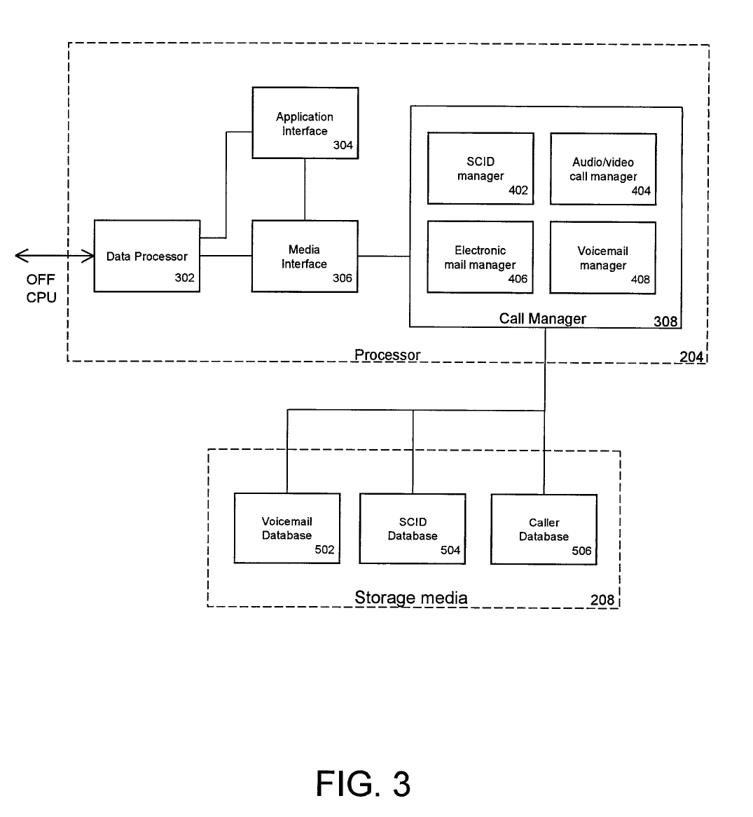

FIG. 3 is an expanded functional act diagram of processor 204 and storage medium 208. It is well understood by those in the art, that the functional elements of FIG. 3 may be implemented in hardware, firmware, or as software instructions and data encoded on a computer-readable storage medium 208. As shown in FIG. 3, processor 204 comprises data processor 302, application interface 304, media interface 306, and call manager 308. These structures may be implemented as hardware, firmware, or software encoded on a computer-readable medium, such as storage media 208. In addition, as shown in FIG. 3, storage media 208 may also contain voicemail database 502, SCID database 504, and caller database 506. Any two or more of these databases may be implemented as a single database as desired.

Data processor 302 interfaces with display 214, manual input device 216, storage medium 208, microphone 218, data port 212, video input 210, memory 206, speakers 220, and communications network interface 202. The data processor 302 enables processor 204 to locate data on, read data from, and write data to, these components.

Application interface 304 enables processor 204 to take some action with respect to a separate software application or entity. For example, application interface 304 may take the form of a windowing user interface, as is commonly known in the art.

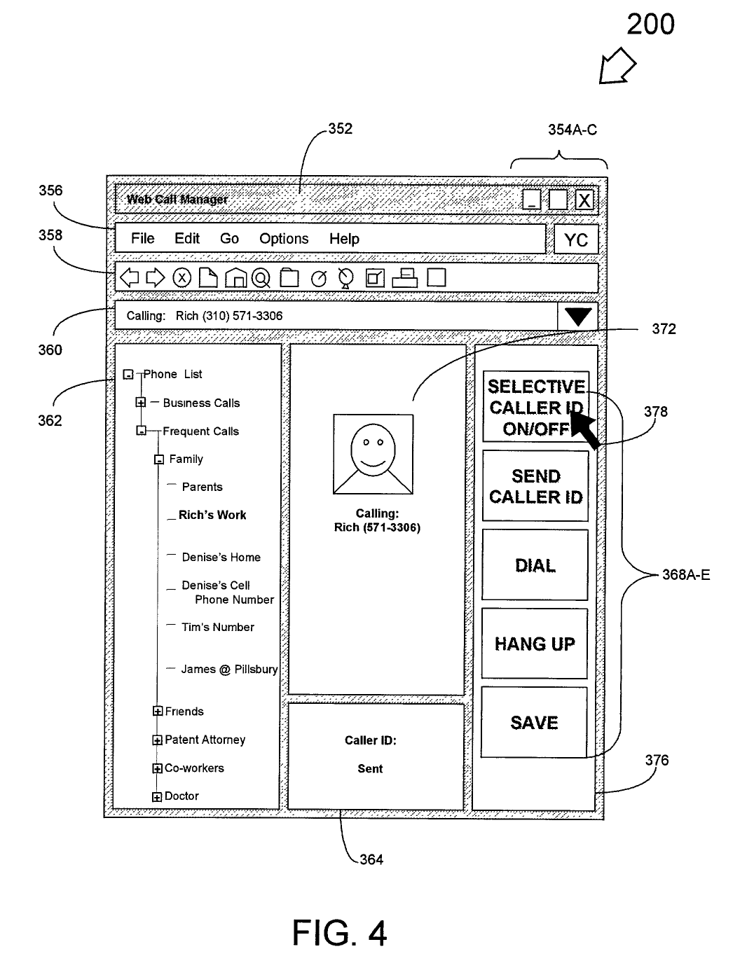

Media interface 306 may be a web-enabled call interface. In some embodiments, the media interface 306 may be a stand-alone program, or a web-browser window. An example of such a media interface window is shown in FIG. 4. Media interface window 200 may comprise title bar 352, window control buttons 354A-C, menu bar 356, button bar 358, address bar 360, phone-list frame 362, main frame 372, status frame 364, and control frame 376.

In some embodiments, main frame 372 displays a picture of the current caller retrieved from caller database 506. In such embodiments, using the mouse pointer 378, user may either click control buttons 368A-E, or “drag-and-drop” callers listed in the phone list frame 362, or pictures of the caller in the main frame 372 to control buttons 368A-E in the control frame 376. Media interface 306 then selects the appropriate structure to execute the functionality specified by the selected control button 368.

Returning to FIG. 3, call manager 308 may further comprise a selective caller identification manager 402, audio/video manager 404, electronic mail manager 406, and voicemail manager 408.

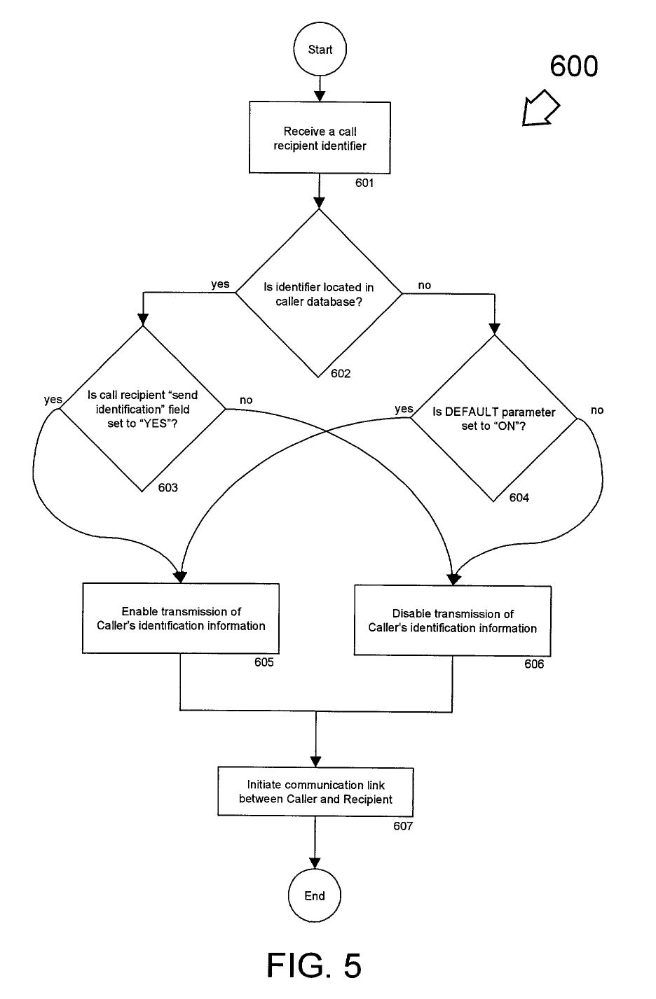

SCID manager 402 allows media interface 306 to selectively transmit identification information to recipients. In addition, SCID manager determines which recipients are sent identification information, and which recipients are not. Audio/video manager 404 allows media interface 306 to utilize video input 210, microphone 218, speaker 220, and display 214 for audio or multimedia, video-based calls. Electronic mail manager 406 allows media interface 306 to communicate through text-base messaging systems, such as electronic mail, instant-messaging programs, or text-messaging pagers. Voicemail manager 408 communicates with media interface 306 and stores messages in voicemail database 502. These components of call manager 308 may interact with any one or more of voicemail database 502, SCID database 504, and caller database 506, and may best be understood with respect to the flowcharts of FIGS. 5, 6A, 6B, 7A, and 7B, as described below. Voicemail database 502, SCID database 504, and caller database 506 may be implemented as one single database or multiple databases as desired.

Embodiments will now be disclosed using examples depicting the operation of SCID. It is understood that these examples, which are used for illustrative purposes only, in no way limit the number of callers, call recipients, types of communication devices, or protocol, that may participate in SCID.

FIG. 5 flowcharts a process 600 to facilitate SCID, constructed and operative in accordance with an embodiment of the present invention. At act 601, caller's communications device 110A receives a recipient identifier. For example, caller dials recipient's telephone number. Caller's communications device 110A then determines whether recipient's identifier is stored within the SCID database 504 at act 602. For example, caller's telephone 110A determines whether the recipient's telephone number is stored within the SCID database 504. If the recipient's identifier is stored within the SCID database 504, caller's communications device 110A then determines whether it should send identification information by referencing the SCID database 504 at act 603. For example, the SCID database 504 may comprise a SEND ID field that indicates whether identification information is to be transmitted to a recipient. The caller's communications device 110A may locate the SEND ID field within the SCID database 504 that corresponds to the recipient identifier. If the SEND ID field indicates that the identification information is to be sent to this recipient, then caller's communications device 110A enables transmission of the identification information at act 605. If the SEND ID field indicates that the identification is not to be sent to this recipient, then caller's communications device 110A disables transmission of the identification information at act 606. If the recipient identifier is not stored within the SCID database 504, caller's communications device 110A then determines whether the DEFAULT parameter is set on or off at act 604. If the DEFAULT parameter is set on, then caller's communications device 110A enables transmission of the identification information at act 605. If the DEFAULT parameter is set off, then caller's communications device 110A disables transmission of the identification information at act 606. Caller's communications device 110A then initiates a communications link between caller and recipient at act 607. For example, caller's telephone then dials recipient's telephone number.

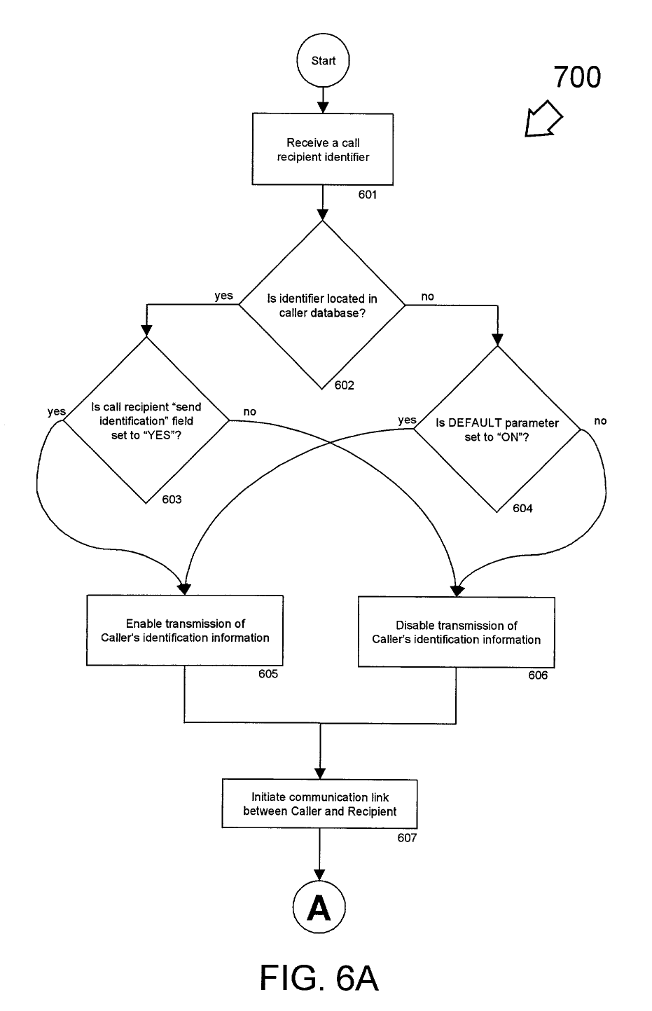

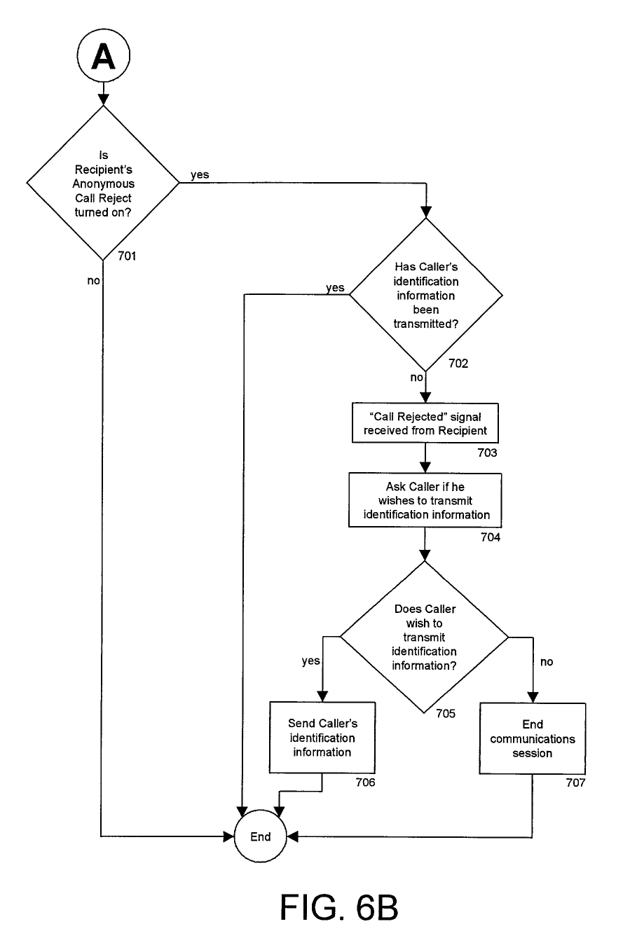

FIGS. 6A-B flowchart another process 700 to facilitate SCID, constructed and operative in accordance with an embodiment of the present invention. In this embodiment, caller initiates a communications session with recipient as described in FIG. 6, but if recipient has enabled a call-filtering function on his communications device 110B, such as Anonymous Call Reject, the caller is given the opportunity to manually transmit his identification information so that the communications session may occur.

At act 601, caller's communications device 110A receives a recipient identifier. For example, caller dials recipient's telephone number. Caller's communications device 110A then determines whether recipient's identifier is stored within the SCID database 504 at act 602. For example, caller's telephone 110A determines whether the recipient's telephone number is stored within the SCID database 504. If the recipient's identifier is stored within the SCID database 504, caller's communications device 110A then determines whether it should send identification information by referencing the SCID database 504 at act 603. For example, the SCID database 504 may comprise a SEND ID field that indicates whether identification information is to be transmitted to a recipient. The caller's communications device 110A may locate the SEND ID field within the SCID database 504 that corresponds to the recipient identifier. If the SEND ID field indicates that the identification information is to be sent to this recipient, then caller's communications device 110A enables transmission of the identification information at act 605. If the SEND ID field indicates that the identification is not to be sent to this recipient, then caller's communications device 110A disables transmission of the identification information at act 606. If the recipient identifier is not stored within the SCID database 504, caller's communications device 110A then determines whether the DEFAULT parameter is set on or off at act 604. If the DEFAULT parameter is set on, then caller's communications device 110A enables transmission of the identification information at act 605. If the DEFAULT parameter is set off, then caller's communications device 110A disables transmission of the identification information at act 606. Caller's communications device 110A then initiates a communications link between caller and recipient at act 607. For example, caller's telephone then dials recipient's telephone number.

After initiating a communications link between caller and recipient, caller's communications device 110A determines if recipient has enabled a call-filtering feature, such as Anonymous Call Reject, at act 701. Anonymous Call Reject, as commonly known in the art, is a telephone communications function whereby a telephone call recipient's telephone equipment will automatically reject incoming telephone calls from callers who have not enabled the transmission of their identification information. If recipient has not enabled a filtering function such as Anonymous Call Reject, the SCID process ends. If recipient has enabled a filtering function, such as Anonymous Call Reject, caller's communications device 110A determines whether the transmission of the identification has been enabled at act 702. If the transmission of the identification information has been enabled, SCID ends. If the transmission of the identification information has not been enabled, caller's communications device 110A receives a “call rejected” signal from recipient's communications device 110B at act 703. Caller's communication device 110A then asks caller if he wishes to transmit his identification information to recipient at act 704. Caller's communications device 110A then determines whether or not caller wishes to transmit his identification information at act 705. If caller does wish to send his identification information, caller's communications device 110A transmits caller's identification information at act 706. If caller does not wish to send his identification information to recipient, then caller's communications device 110A ends the communications session at act 707.

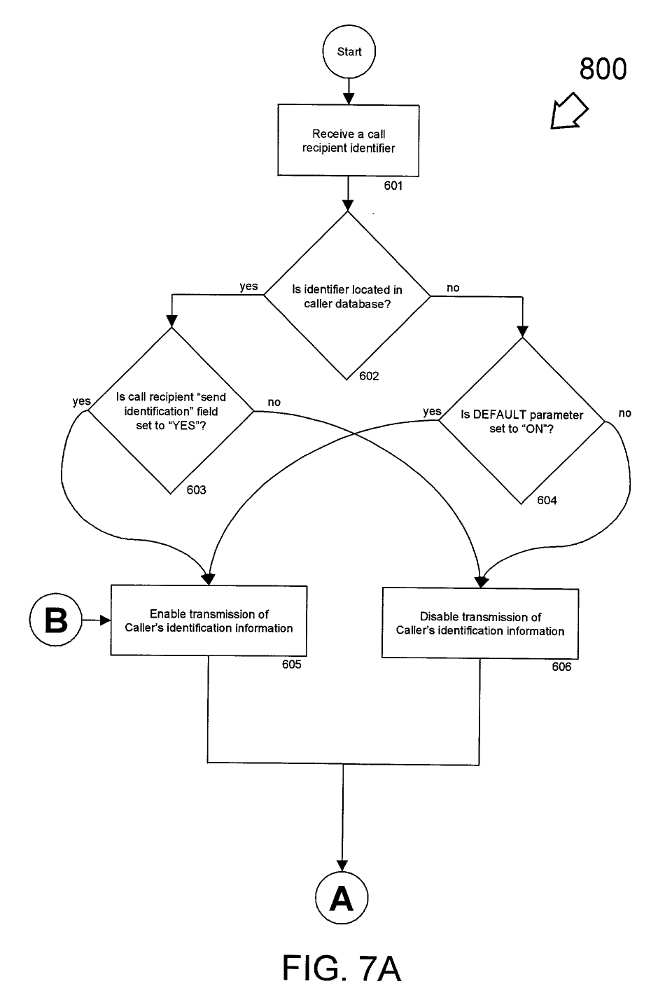

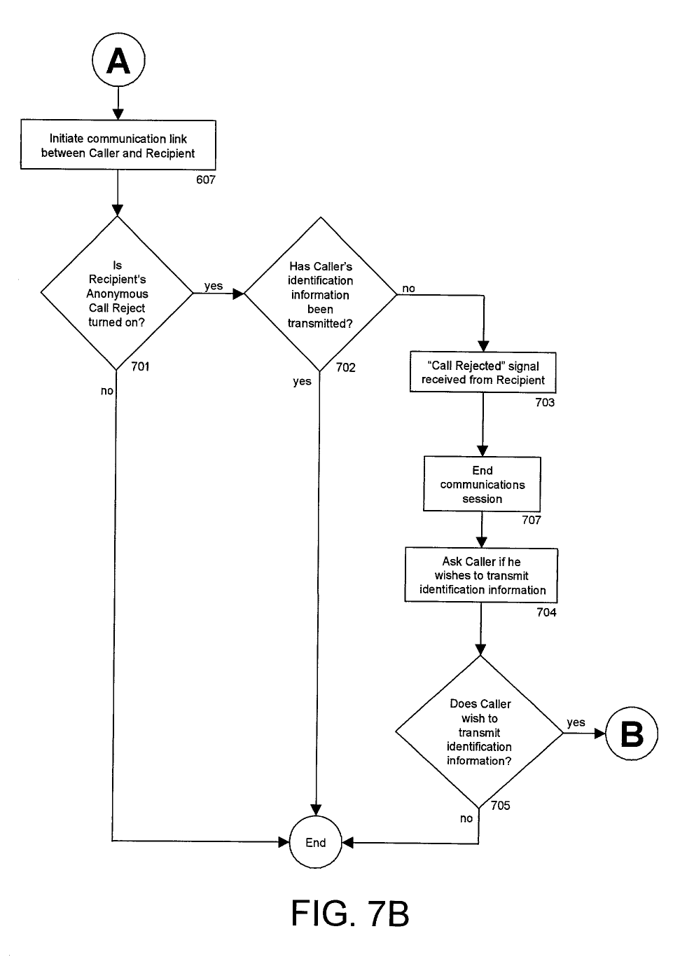

FIGS. 7A-B flowchart another process 800 to facilitate SCID, constructed and operative in accordance with an embodiment of the present invention. In this embodiment, Caller initiates a communications session with Recipient as described in FIG. 6, but if recipient has enabled a call-filtering function on his communications device 110B, such as Anonymous Call Reject, caller's communications device 110A enables or disables the transmission of the identification information, and automatically redial recipient.

At act 601, caller's communications device 110A receives a recipient identifier. For example, caller dials recipient's telephone number. Caller's communications device 110A then determines whether recipient's identifier is stored within the SCID database 504 at act 602. For example, caller's telephone 110A determines whether the recipient's telephone number is stored within the SCID database 504. If the recipient's identifier is stored within the SCID database 504, caller's communications device 110A then determines whether it should send identification information by referencing the SCID database 504 at act 603. For example, the SCID database 504 may comprise a SEND ID field that indicates whether identification information is to be transmitted to a recipient. The caller's communications device 110A may locate the SEND ID field within the SCID database 504 that corresponds to the recipient identifier. If the SEND ID field indicates that the identification information is to be sent to this recipient, then caller's communications device 110A enables transmission of the identification information at act 605. If the SEND ID field indicates that the identification is not to be sent to this recipient, then caller's communications device 110A disables transmission of the identification information at act 606. If the recipient identifier is not stored within the SCID database 504, caller's communications device 110A then determines whether the DEFAULT parameter is set on or off at act 604. If the DEFAULT parameter is set on, then caller's communications device 110A enables transmission of the identification information at act 605. If the DEFAULT parameter is set off, then caller's communications device 110A disables transmission of the identification information at act 606. Caller's communications device 110A then initiates a communications link between caller and recipient at act 607. For example, caller's telephone then dials recipient's telephone number.

After initiating a communications link between caller and recipient, caller's communications device 110A determines if recipient has enabled a call-filtering feature, such as Anonymous Call Reject, at act 701. If recipient has not enabled a call-filtering function such as Anonymous Call Reject, the SCID process ends. If the recipient has enabled a filtering function, such as Anonymous Call Reject, caller's communications device 110A determines whether the identification information has been transmitted at act 702. If the identification information has been transmitted, SCID ends. If the identification information has not been transmitted, caller's communications device 110A receives a “call rejected” signal from recipient's communications device 110B at act 703, and then ends the communications session at act 707. Caller's communications device 110A then asks caller whether he wishes to transmit his identification information to recipient at act 704. Caller's communications device 110A then determines whether caller wishes to transmit his identification information to recipient at act 705. If caller does not wish to transmit his identification information to recipient, the SCID process ends. If caller does wish to transmit his identification information to recipient, caller's communications device 110A enables the transmission of the identification information at act 605, and then initiates a communications session between caller and recipient at act 607. Caller's communications device 110A will then determine whether recipient's call-filtering function is still enabled at act 701, and then, whether the identification information has been transmitted at act 702. Having just enabled the transmission of the identification information at act 605, caller's communications device 110A will then end the SCID process.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A method comprising:
receiving a call recipient identifier;
searching a database for the call recipient identifier;
configuring a communications device to enable transmission of an identification of a caller when the call recipient identifier is located within the database and a send identification field for the call recipient identifier comprises a “send identification” flag.

2. The method of claim 1, further comprising:
configuring the communications device to disable transmission of the identification of the caller when the call recipient identifier is located within the database and the send identification field for the call recipient identifier comprises a “do not send identification” flag.

3. The method of claim 1, further comprising:
configuring the communications device to enable transmission of the identification of the caller when the call recipient identifier is not located within the database and a default parameter comprises a “send identification” setting.

4. The method of claim 1, further comprising:
configuring the communications device to disable transmission of the identification of the caller when the call recipient identifier is not located within the database and the default parameter comprises a “do not send identification” setting.

5. The method of claim 1, further comprising:
attempting to establish a communications link between the caller and a call recipient.

6. The method of claim 1, further comprising:
enabling transmission of the identification of the caller when the call recipient has enabled a call filter and the caller performs a “send identification” command.

7. The method of claim 6, wherein the call filter is Anonymous Call Reject.

8. The method of claim 6, further comprising:
attempting to establish the communications link between the caller and the call recipient.

9. The method of claim 1, further comprising:
disabling transmission of the identification of the caller when the call recipient has enabled the call filter and the caller performs a “do not send identification” command.

10. The method of claim 9, wherein the call filter is Anonymous Call Reject.

11. The method of claim 1, wherein the call recipient identifier comprises a telephone number.

12. The method of claim 1, wherein the call recipient identifier comprises an e-mail address.

13. The method of claim 1, wherein the call recipient identifier comprises an Internet Protocol (IP) address.

14. The method of claim 1, wherein the call recipient identifier comprises a name.

15. The method of claim 1, wherein the identification comprises a telephone number.

16. The method of claim 1, wherein the identification comprises an e-mail address.

17. The method of claim 1, wherein the identification comprises an Internet Protocol (IP) address.

18. The method of claim 1, wherein the identification comprises a name.

19. An apparatus comprising:
a database;
a call manager configured to receive a call recipient identifier, and enable the transmission of an identification of a caller when the call recipient identifier is located within the database and a send identification field for the call recipient identifier comprises a “send identification” flag.

20. The apparatus of claim 19, wherein the call manager is configured to receive the call recipient identifier and disable transmission of the identification of the caller when the call recipient identifier is located within the database and the send identification field for the call recipient identifier comprises a “do not send identification” flag.

21. The apparatus of claim 19, wherein the call manager is configured to receive the call recipient identifier and enable transmission of the identification of the caller when the call recipient identifier is not located within the database and a default parameter comprises a “send identification” setting.

22. The apparatus of claim 19, wherein the call manager is configured to receive the call recipient identifier and disables transmission of the identification of the caller when the call recipient identifier is not located within the database and the default parameter comprises a “do not send identification” setting.

23. The apparatus of claim 19, wherein the call manager attempts to establish a communications link between the caller and a call recipient.

24. The apparatus of claim 19, wherein the call manager enables transmission of the identification of the caller when the call recipient has enabled a call filter and the caller performs a “send identification” command.

25. The apparatus of claim 24, wherein the call filter is Anonymous Call Reject.

26. The apparatus of claim 24, wherein the call manager attempts to establish the communications link between the caller and the call recipient.

27. The apparatus of claim 19, wherein the call manager disables transmission of the identification of the caller when the call recipient has enabled the call filter and the caller performs a “do not send identification” command.

28. The apparatus of claim 27, wherein the call filter is Anonymous Call Reject.

29. The apparatus of claim 19, wherein the call recipient identifier comprises a telephone number.

30. The apparatus of claim 19, wherein the call recipient identifier comprises an e-mail address.

31. The apparatus of claim 19, wherein the call recipient identifier comprises an Internet Protocol (IP) address.

32. The apparatus of claim 19, wherein the call recipient identifier comprises a name.

33. The apparatus of claim 19, wherein the identification comprises a telephone number.

34. The apparatus of claim 19, wherein the identification comprises an e-mail address.

35. The apparatus of claim 19, wherein the identification comprises an Internet Protocol (IP) address.

36. The apparatus of claim 19, wherein the identification comprises a name.

37. The apparatus of claim 19, wherein the storage media is located internally.

38. The apparatus of claim 19, wherein the storage media is located externally.

39. The apparatus of claim 19, wherein the storage media comprises a magnetic disk drive.

40. The apparatus of claim 19, wherein the storage media comprises a floppy disk drive.

41. The apparatus of claim 19, wherein the storage media comprises a compact-disk read-only-memory (CD-ROM) drive.

42. The apparatus of claim 19, wherein the storage media comprises a transistor-based memory.

43. An apparatus comprising:
means for receiving a call recipient identifier;
means for searching a database for the call recipient identifier;
means for configuring a communications device to enable transmission of an identification of a caller when the call recipient identifier is located within the database and a send identification field for the call recipient identifier comprises a “send identification” flag.

44. The apparatus of claim 43, further comprising:
means for configuring the communications device to disable transmission of the identification of the caller when the call recipient identifier is located within the database and the send identification field for the call recipient identifier comprises a “do not send identification” flag.

45. The apparatus of claim 43, further comprising:
means for configuring the communications device to enable transmission of the identification of the caller when the call recipient identifier is not located within the database and a default parameter comprises a “send identification” setting.

46. The apparatus of claim 43, further comprising:
means for configuring the communications device to disable transmission of the identification of the caller when the call recipient identifier is not located within the database and the default parameter comprises a “do not send identification” setting.

47. The apparatus of claim 43, further comprising:
means for attempting to establish a communications link between the caller and a call recipient.

48. The apparatus of claim 43, further comprising:
means for enabling transmission of the identification of the caller when the call recipient has enabled a call filter and the caller performs a “send identification” command.

49. The apparatus of claim 48, wherein the call filter is Anonymous Call Reject.

50. The apparatus of claim 48, further comprising:
means for attempting to establish the communications link between the caller and the call recipient.

51. The apparatus of claim 43, further comprising:
means for disabling transmission of the identification of the caller when the call recipient has enabled the call filter and the caller performs a “do not send identification” command.

52. A computer-readable medium encoded with data and instructions, the data and instructions causing an apparatus executing the instructions to:
receive a call recipient identifier;
search a database for the call recipient identifier;
configure a communications device to enable transmission of an identification of a caller when the call recipient identifier is located within the database and a send identification field for the call recipient identifier comprises a “send identification” flag.

53. The computer-readable medium of claim 52, further encoded with data and instructions to:
configure the communications device to disable transmission of the identification of the caller when the call recipient identifier is located within the database and the send identification field for the call recipient identifier comprises a “do not send identification” flag.

54. The computer-readable medium of claim 52, further encoded with data and instructions to:
configure the communications device to enable transmission of the identification of the caller when the call recipient identifier is not located within the database and a default parameter comprises a “send identification” setting.

55. The computer-readable medium of claim 52, further encoded with data and instructions to:
configure the communications device to disable transmission of the identification of the caller when the call recipient identifier is not located within the database and the default parameter comprises a “do not send identification” setting.

56. The computer-readable medium of claim 52, further encoded with data and instructions to:
attempt to establish a communications link between the caller and a call recipient.

57. The computer-readable medium of claim 52, further encoded with data and instructions to:
enable transmission of the identification of the caller when the call recipient has enabled a call filter and the caller performs a “send identification” command.

58. The computer-readable medium of claim 57, wherein the call filter is Anonymous Call Reject.

59. The computer-readable medium of claim 57, further encoded with data and instructions to:
attempt to establish the communications link between the caller and the call recipient.

60. The computer-readable medium of claim 52, further encoded with data and instructions to:
disable transmission of the identification of the caller when the call recipient has enabled the call filter and the caller performs a “do not send identification” command.

61. The computer-readable medium of claim 60, wherein the call filter is Anonymous Call Reject.

62. The computer-readable medium of claim 52, wherein the call recipient identifier comprises a telephone number.

63. The computer-readable medium of claim 52, wherein the call recipient identifier comprises an e-mail address.

64. The computer-readable medium of claim 52, wherein the call recipient identifier comprises an Internet Protocol (IP) address.

65. The computer-readable medium of claim 52, wherein the call recipient identifier comprises a name.

66. The computer-readable medium of claim 52, wherein the identification comprises a telephone number.

67. The computer-readable medium of claim 52, wherein the identification comprises an e-mail address.

68. The computer-readable medium of claim 52, wherein the identification comprises an Internet Protocol (IP) address.

69. The computer-readable medium of claim 52, wherein the identification comprises a name.
